(19) United States
(12) Patent Application Publication
(10) Pub. No.: US 2011/0173043 A1
(43) Pub. Date: Jul. 14, 2011

(54) METHOD FOR DESIGNING INDUSTRIAL SYSTEMS

(76) Inventor: Rupert Maier, Eggolsheim (DE)

(21) Appl. No.: 12/986,623

(22) Filed: Jan. 7, 2011

(30) Foreign Application Priority Data
Jan. 8, 2010 (DE) 10 2010 004 192.0

(51) Int. Cl. G06Q 10/00

(52) U.S. Cl. 705/7.27

(57) ABSTRACT

Method and engineering system for designing industrial systems on the basis of system-independent, rule-based, configurable, incremental workflow objects, with a tree of relevant workflow objects that represents the workflow requiring to be executed for generating the engineering documents of the target system that is being designed being generated from the general workflow objects by functional decompensation, and with a system layout being generated from the identified system objects and by way of interpreting the data, objects, and rules of the workflow objects contained in the tree, these being processed, and with the engineering documentation necessary for the system that is being designed being generated in the respectively required format by document generators in the form of resulting machine-readable engineering documents. Alongside system objects and engineering objects, especially the successively accumulated engineering knowledge that has been filed on a standardized basis is reused.

### CROSS-REFERENCE TO RELATED APPLICATIONS

This application claims priority to DE Patent Application No. 10 2010 004 192.0 filed Jan. 8, 2010. The contents of which is incorporated herein by reference in its entirety.

### TECHNICAL FIELD

The invention relates to a method and a device for designing industrial systems on the basis of system-independent, rule-based, configurable workflow objects. The invention relates further to a computer-program product and a computer-readable medium each suitable for implementing the method.

### BACKGROUND

Engineering is too expensive overall because engineering data and engineering decisions are too seldom reused across different projects in the design of industrial systems. The reason is that on the one hand the customers expect individual partial solutions at individual locations and, on the other hand, individual identical partial solutions of other projects are as a rule difficult to isolate and consequently often cannot be automatically integrated into a new engineering project. Many engineering decisions are furthermore based on non-traceable or, as the case may be, non-reproducible arguments or rules and are often dependent on the background of the persons involved in terms of their experience. Individual specific decisions of such kind result in individual solutions that are not very standardized.

One approach to a solution is to identify and employ what are termed “mechatronic objects”. The aim therein is to simplify engineering by interconnecting reusable objects that are as large as possible, manually identified, and defined in advance. Construction-field boundaries should therein as far as possible cease to apply and the overall system be developed from the individual mechatronic objects through modeling. That approach is based on the assumption that large, flexible, reusable components can be defined in the form of mechatronic objects. Objects of such kind are, though, often relatively difficult to define in practice because in defining such objects it is often not possible to obtain a clear overview of the various types of application or, as the case may be, they are still unknown. “Mechatronic objects” prove very quickly to pose a relatively major limitation owing to the description—encapsulated therein and defined in advance—of a system section. Customers' individual wishes can therefore be accommodated to a limited extent only.

US patent specification U.S. Pat. No. 6,119,125 discloses a computer-implemented system for producing applications for building automation based on predefined standard objects that can be interconnected.

### SUMMARY

According to various embodiments, a method for designing industrial systems on the basis of system-independent, rule-based, configurable workflow objects, can be provided by which method the engineering of industrial systems is successively simplified by means of automated knowledge accumulation and the use of incremental system objects.

According to an embodiment, in a method for designing industrial systems on the basis of system-independent, rule-based, configurable workflow objects, with a workflow object including—a standardized machine-readable description of an incremental engineering task,—a standardized machine-readable description of data and objects that are consumed and/or generated in the performance of the engineering task,—standardized machine-readable rules according to which the engineering task is to be performed,
the specification of requirements applying to the system that is being designed being compiled on the basis of standardized machine-readable requirements,
the workflow objects and system objects necessary for generating the engineering tasks required by the specification of requirements being identified from a set of workflow objects and a set of system objects representing physical system components of an industrial system requiring to be designed, and
a tree of workflow objects that represents the workflow requiring to be executed for generating the engineering documents of the target system that is being designed being generated from the identified workflow objects by means of functional decompensation, and
a system layout being generated from the identified system objects and by way of interpreting the data, objects, and rules of the workflow objects contained in the tree, these being processed by a workflow engine, and
the engineering documentation necessary for the system that is being designed being generated in the respectively required format by document generators in the form of resulting engineering documents.

According to a further embodiment, requirements can be converted into a machine-readable form if not already in a machine-readable form. According to a further embodiment, the workflow objects can be classified as being domain-specific or, as the case may be, discipline-specific and non-domain-specific or, as the case may be, non-discipline-specific. According to a further embodiment, from the set of all project-specifically employed workflow objects the workflow objects that were produced, modified, or processed manually can be identified, and wherein said workflow objects are transferred to the set of machine-readable workflow objects with the associated data, objects, and rules. According to a further embodiment, before the data, objects, and rules are transferred to the set of machine-readable workflow objects the latter can be classified as being domain-specific or, as the case may be, discipline-specific and non-domain-specific or, as the case may be, non-discipline-specific. According to a further embodiment,

before the data, objects, and rules are transferred to the set of machine-readable workflow objects the latter can be analyzed in terms of a general applicability.

According to another embodiment, a device, in particular an engineering system, may implement a method as described above.

According to yet another embodiment, a computer-program product may cause a method as described above to be implemented on a program-controlled device.

According to yet another embodiment, a computer-readable medium may include instructions which, when executed on a suitable computer system, will cause the computer system to implement the method as described above.

### BRIEF DESCRIPTION OF THE DRAWINGS

An exemplary embodiment is shown in the drawing and explained below.

FIG. 1 is an exemplary schematic overview of conventional engineering,

FIG. 2 is an exemplary schematic overview of engineering with the aid of mechatronic objects,

FIG. 3 is an exemplary schematic overview of engineering with the aid of rule-based workflow objects (RWO),

FIG. 4 shows an exemplary effect of a rule-based workflow object (RWO),

FIG. 5 shows an exemplary RWO tree after decomposition of the original and derived requirements,

FIG. 6 is a schematic exemplary overview diagram showing the interoperation of components for implementing the method according to various embodiments, and

FIG. 7 shows an exemplary engineering system for implementing the method according to various embodiments.

### DETAILED DESCRIPTION

According to various embodiments, in a method for designing industrial systems on the basis of system-independent, rule-based, configurable workflow objects, with a workflow object including:
A standardized machine-readable description of an incremental engineering task,
a standardized machine-readable description of data and objects that are consumed and/or generated in the performance of the engineering task,
standardized machine-readable rules according to which the engineering task is to be performed,
   with the specification of requirements applying to the system that is being designed being compiled on the basis of standardized machine-readable requirements,
the workflow objects and system objects necessary for generating the engineering tasks required by the specification of requirements being identified from a set of workflow objects and a set of system objects representing physical system components of an industrial system requiring to be designed, and a tree of workflow objects that represents the workflow requiring to be executed for generating the engineering documents of the target system that is being designed being generated from the identified workflow objects by means of functional decompensation, and with a system layout being generated from the identified system objects and by way of interpreting the data, objects, and rules of the workflow objects contained in the tree, these being processed by a workflow engine, and with the engineering documentation necessary for the system that is being designed being generated in the respectively required format by document generators in the form of resulting engineering documents. In contrast to the customary methods (as is customary with mechatronic objects, for instance) of reusing individual, as large as possible system sections along with their engineering data and then adapting and integrating them manually, individual elementary behavior patterns and behavior rules as well as processing steps (meaning the engineering knowledge itself) are in the various embodiments encapsulated in elementary workflow objects. It is therein characterized which engineering process can be employed in what circumstances (requirements). For handling specific engineering projects (system handling of industrial systems) finally the respective requirements are interpreted on an automated basis and, proceeding therefrom, the appropriate rule-based workflow objects are identified and adapted to the specific task in hand then combined into an overall workflow. All individual tasks of the workflows or, as the case may be, overall workflow that can be automated are handled automatically. Alongside system objects and engineering objects, especially the successively accumulated engineering knowledge that has been filed on a standardized basis is reused in the case of the method according to various embodiments. The result is that the overall workflow for handling an industrial system's engineering will be compiled from numerous standardized partial workflows and the individual engineering tasks will be handled on an automated basis wherever possible (meaning where the filed knowledge suffices). Any tasks still remaining in the workflow that actually require new engineering knowledge not yet present within the system will have to be performed manually. The method can be employed for production systems (chip fabrication for instance), for assembly systems (printed circuit board assembly for instance), or for process-engineering systems (the chemical industry or breweries for instance).

In one embodiment, the requirements are converted into a machine-readable form if not already in a machine-readable form. Converting the requirements into a machine-readable form (for example into the Requirement Description Language RDL or into CiNii) will enable them to be processed fully automatically with computer support.

In another embodiment, the workflow objects are classified as being domain-specific or, as the case may be, discipline-specific and non-domain-specific or, as the case may be, non-discipline-specific. That will make it easier to search for suitable objects for the system engineering and enhance their reuse.

In another embodiment, from the set of all project-specifically employed workflow objects the workflow objects that were produced, modified, or processed manually are identified, and with said workflow objects being transferred to the set of machine-readable workflow objects along with the associated data, objects, and rules. The method according to various embodiments thus has a feedback loop via which all new or modified procedures are identified and filed into the system as new engineering steps (in the form of rules) that can in future be performed on an automated basis. The engineering knowledge contained in the databases (set of workflow objects, set of system objects) will in that way gradually increase so that it will be possible over time for more and more engineering activities to be processed (interpreted, adapted, and employed) automatically. According to various embodiments, a learning system is proposed in the case of which the engineering of industrial systems is successively simplified through automated knowledge accumulating and use.

In another embodiment, before the data, objects, and rules are transferred to the set of machine-readable workflow objects the latter are classified as being domain-specific or, as the case may be, discipline-specific and non-domain-specific or, as the case may be, non-discipline-specific. That will enable reusable workflow objects to be produced systematically.

In another embodiment, before the data, objects, and rules are transferred to the set of machine-readable workflow objects the latter are analyzed in terms of a general applicability. Non-domain-specific or, as the case may be, non-discipline-specific workflow objects can be detected and classified thereby, as a result of which the workflow objects' reusability will be enhanced.

The object is further achieved by means of a device, in particular an engineering system for modeling technical systems, suitable for implementing one of the methods according to various embodiments. The engineering system can be a commercially available computer (for example a PC or workstation) having appropriate software with modeling tools (for example a UML working environment) for implementing the method. A suitably equipped industrial PC can also be used as the computer depending on the requirements and working environment.

The object is further achieved by means of a computer-program product or computer-readable medium causing the method to be implemented on a program-controlled device. That will enhance the flexibility of the method's use according to various embodiments as well as facilitating its distribution and commercial sale.

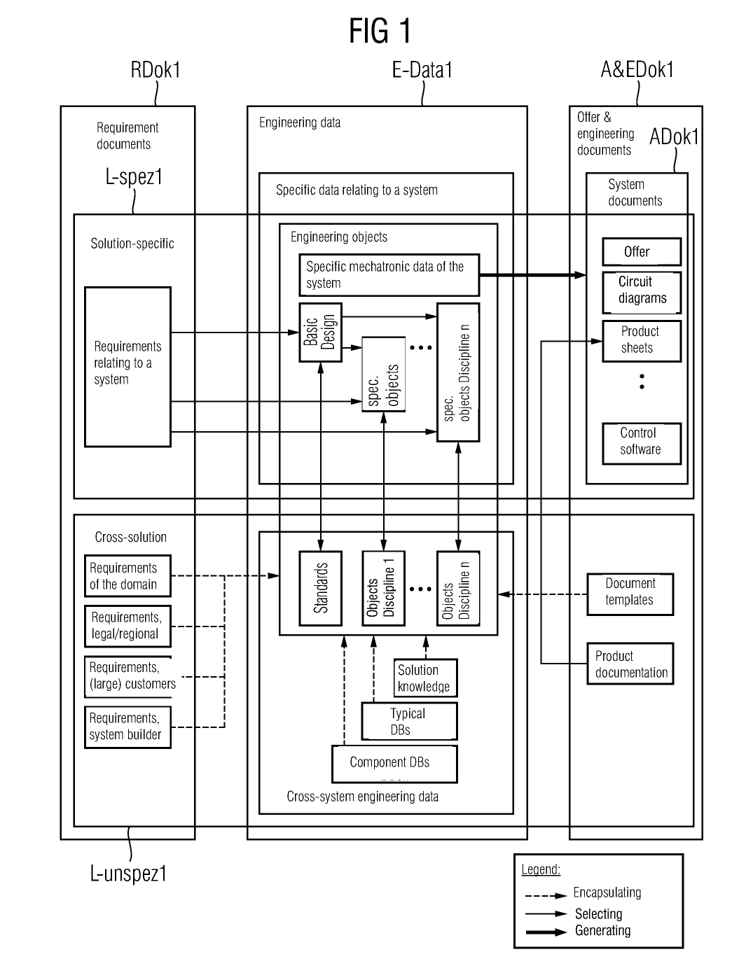

FIG. 1 is an exemplary schematic overview of conventional system engineering. FIG. 1 shows the interoperation of and flow of information between the requirements or, as the case may be, requirement documents RDok1, the engineering data E-Data1, and the offer & engineering documents A&EDok1. FIG. 1 furthermore classifies the documents and data for system engineering into a solution-specific sector L-spez1 and a cross-solution sector L-unspez1. In the case of the engineering data E-Data1 there therefore exists specific data relating to a system, which data is used in dedicated fashion only in a specific “system instance”, and “cross-system engineering data” that is used in a plurality of systems or, as the case may be, “system instances”. The cross-system engineering data includes, for example, solution knowledge, typical databases (containing, for example, standard solutions or standard objects), or component databases containing standard components (for example conveyor belts, ovens, heating elements). The cross-system engineering data also includes discipline-specific objects and standards and norms. In the case of the offer & engineering documents A&EDok1 the system documents ADok1 that include, inter alia, the offer, circuit diagrams, product sheets, and the control software belong to the solution-specific sector L-spez1.

The arrows in FIG. 1 indicate the workflow between the documents RDok1, A&EDok1 and data E-Data 1. Information encapsulating (for example the encapsulating of requirements from the cross-solution sector L-unspez1 of the requirement documents RDok1 in standards and discipline-specific objects of the “cross-system engineering data” sector of the engineering data E-Data1) is indicated by the dashed arrows. A thin unbroken arrow indicates a design decision, for example in the solution-specific sector L-spez1 from the “Requirements for a system” to the “Basic Design” of the engineering data E-Data1. A thick unbroken arrow indicates generating, for example generating system documents ADok1 from “Specific mechatronic data of the system”.

What frequently dominates in conventional system engineering is manual “copying & modifying” of workflows and partial solutions from previous projects, with the following consequences:
Considerable manual effort to identify which parts can be used and to adapt them to the respective target system.
“Corpses” are left behind.
Considerable proneness to error when there are “slight” deviations in the requirements.
Insufficient tool support in requirement management, tracing, and claiming.

With the conventional procedure, many engineering decisions are often based on non-traceable or, as the case may be, non-reproducible arguments or rules and are often dependent on the background of the persons involved in terms of their experience. Individual specific decisions of such kind result in individual solutions that are not very standardized and often suboptimal. Complex technological correlations where specific, individual issues result in totally different approaches to a solution impede the full-coverage use of large prefabricated typicals or, as the case may be, mechatronic objects. System-setup time is often a bottleneck of decisive significance. But even trivial engineering decisions are still taken manually despite generally making up the lion's share of the engineering work.

Engineering is too expensive overall because engineering data and engineering decisions are too seldom reused in the case of the conventional procedure. The reason is that on the one hand the customers expect individual partial solutions at individual locations and, on the other hand, individual identical partial solutions of other projects are as a rule difficult to isolate and consequently often cannot be automatically integrated into a new engineering project. The situation worsens over time because instead of standards several similar but not identical solutions will in that way gradually develop for the same partial tasks.

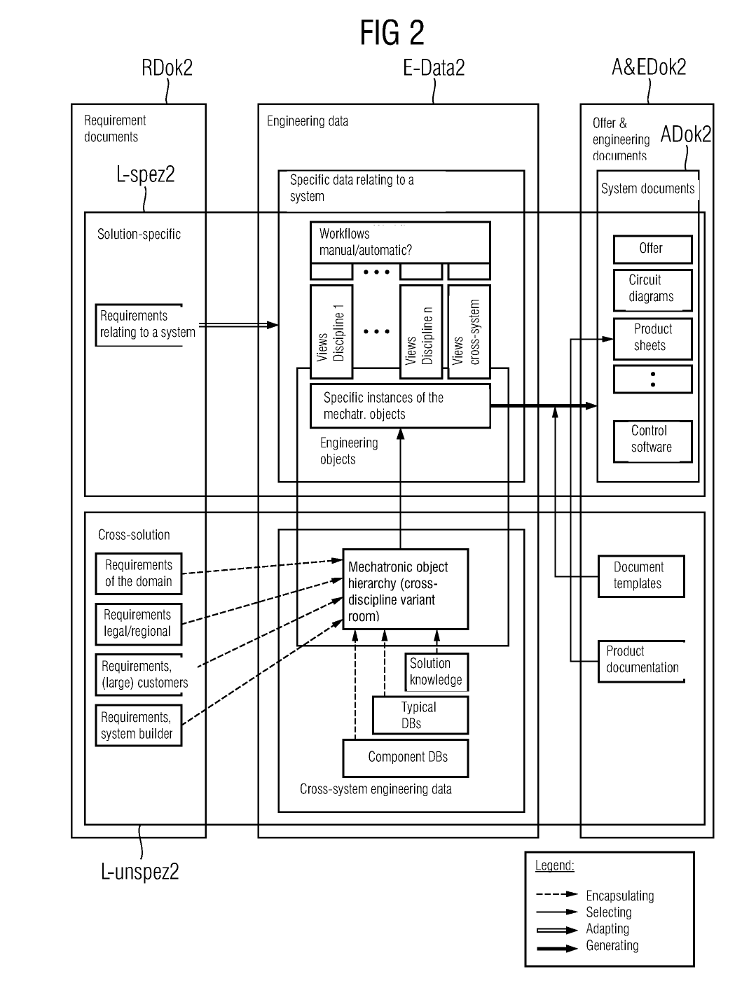

FIG. 2 is an exemplary schematic overview of the engineering of systems with the aid of mechatronic objects. The term mechatronic describes the interaction of different disciplines such as—depending on the specific sector and requirements—mechanical engineering, electrical engineering, or automation, and other information about activities supporting engineering or, as the case may be, project handling in various ways (for example sales, costing, project managing etc.). All said mechatronic information can be referred to the technical components being used. Said interaction is described via a digital representation of the object, what is termed the mechatronic object. A mechatronic object can therein have various what are termed facets, for example one facet for each discipline. The facets constitute a respective discipline's data. Software principles such as, for instance, the locality principle and data encapsulating are taken into account thereby in a simple manner.

Like FIG. 1, FIG. 2 also shows the interoperation of and flow of information between the requirements or, as the case may be, the requirement documents RDok2, the engineering data E-Data2, and the offer & engineering documents A&EDok2. FIG. 2 furthermore classifies the documents and data for system engineering into a solution-specific sector L-spez2 and a cross-solution sector L-unspez2. In the case of the engineering data E-Data2 there therefore exists specific data relating to a system, which data is used in dedicated fashion only in a specific “system instance” and “cross-system engineering data” that is used in a plurality of systems or, as the case may be, “system instances”. The cross-system engineering data includes, for example, solution knowledge, typical databases (containing, for example, standard solutions or standard objects) or component databases containing standard components (for example conveyor belts, ovens, heating elements). Mechatronic object hierarchies and reusable mechatronic object classes are also included in the cross-system engineering data in the case of system engineering according to FIG. 2. Specific instances of mechatronic objects for use in a specific system are generated from the mechatronic object hierarchies and reusable mechatronic object classes. Said specific instances of mechatronic objects are included in the solution-specific sector in the case of engineering data E-Data2.

In the case of the offer & engineering documents A&EDok2 the system documents ADok2 which include, inter alia, the offer, power-on and customer documents such as circuit diagrams, product sheets, and the control software belong to the solution-specific sector L-spez2.

The arrows in FIG. 2 indicate the workflow between the documents RDok2, A&EDok2, and data E-Data2. The encapsulating of information is indicated by the dashed arrows (for example the encapsulating of requirements from the cross-solution sector L-unspez2 of the requirement documents RDok2 into the mechatronic object hierarchies and reusable mechatronic object classes of the (cross-system) engineering data E-Data2). A thin unbroken arrow indicates a selection as the design decision, for example the selection of a specific mechatronic object (an object “conveyor belt”, for instance) from the mechatronic object hierarchy for specific instantiation in a specific system. A thick unbroken arrow indicates generating, for example generating system documents ADok2 from “Specific instances of the mechatronic objects” for a specific system. A double arrow indicates an adaptation, for example the adaptation of the “Requirements for a system” from the solution-specific requirement documents RDok2 to the “Specific data of a system” of the engineering data E-Data2.

FIG. 2 describes the procedure for system engineering with the use of what are termed “mechatronic objects”. The aim is to simplify engineering by interconnecting reusable objects that are as large as possible, manually identified, and defined in advance. Construction-field boundaries should therein as far as possible cease to apply and the overall system be developed from the individual mechatronic objects through modeling. That approach is based on the assumption that large, flexible, reusable components can be defined in the form of mechatronic objects. Objects of such kind are, though, often relatively difficult to define in practice because in defining such objects it is often not possible to obtain a clear overview of the various types of application or, as the case may be, they are still unknown. So the biggest challenge is to identify or, as the case may be, define in the form of objects (in the sense of object orientation) system sections that are as large as possible, standardized, and reusable. The objects are manually adapted to the specific engineering task.

Consequences:
With that approach it is still people who handle a large part of the complex, confusing tasks that involve weighing up which objects are the right ones and discerning where details may need modifying or expanding. It means the knowledge is still largely in the head of relevant experts, who are becoming increasingly rare. There is still only little machine support for that difficult task. Nor can a proposed sequence be derived therefrom for carrying out the requisite manual operations.
“Mechatronic objects” prove very quickly to pose a relatively major limitation owing to the description—encapsulated therein and defined in advance—of a system section. Customers' individual wishes can therefore be accommodated to a limited extent only.
The possibility of identifying an “optimal solution” according to specific criteria (KPIs [Key Performance Indicators], lifecycle considerations, . . . ) is also impeded, limited, or at least scarcely supported. Even the possibility that may be gained therefrom of simulating future system behavior can solve that problem to a limited extent only because the use of large, interconnectable objects will seriously limit the degrees of freedom applying to the system design.

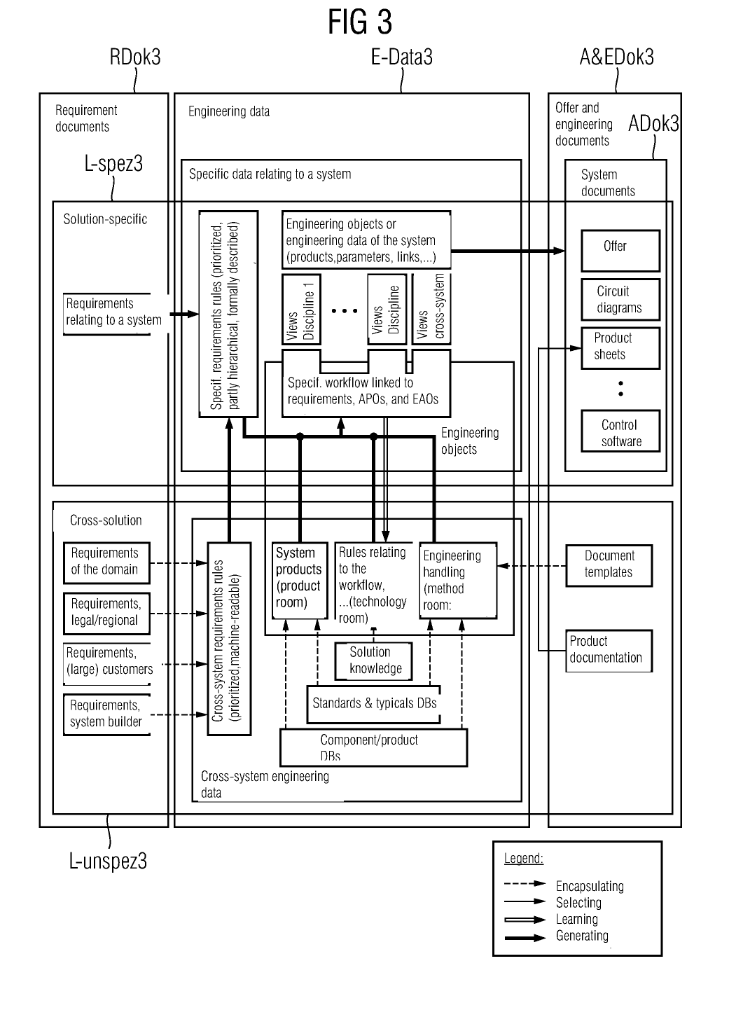

FIG. 3 is an exemplary schematic overview of system engineering with the aid of rule-based workflow objects. FIG. 3 shows the interoperation of and flow of information between the requirements or, as the case may be, requirement documents RDok3, the engineering data E-Data3, and the offer & engineering documents A&EDok3. FIG. 3 furthermore classifies the documents and data for system engineering into a solution-specific sector L-spez3 and a cross-solution sector L-unspez3. In the case of the engineering data E-Data3 there therefore exists specific data relating to a system, which data is used in dedicated fashion only in a specific “system instance”, and “cross-system engineering data” that is used in a plurality of systems or, as the case may be, “system instances”. The cross-system engineering data includes, for example, solution knowledge, standard & typical databases (containing, for example, standard solutions or standard objects) or component/product databases containing standard components (for example conveyor belts, ovens, heating elements). In the case of system engineering based on rule-based workflow objects the cross-system engineering data also includes cross-system requirement rules as well as system products (product room) and rules for the workflow (technology room and information on engineering handling (method room). The specific engineering data relating to a system includes, inter alia, specific requirement rules, engineering objects or, as the case may be, engineering data relating to the system, as well as the specific workflow.

In the case of the offer & engineering documents A&EDok3 the system documents ADok3 that include, inter alia, the offer, power-on and customer documents such as circuit diagrams, product sheets, and the control software belong to the solution-specific sector L-spez3. In the cross-solution sector L-unspez3, document templates and product documentation are included inter alia in the offer & engineering documents A&EDok3.

The arrows in FIG. 3 indicate the workflow between the documents RDok3, A&EDok3 and data E-Data 3. Information encapsulating (for example the encapsulating of requirements from the cross-solution sector L-unspez3 of the requirement documents RDok3 in the “cross-system requirement rules” of the (cross-system) engineering data E-Data3) is indicated by the dashed arrows. A thin unbroken arrow indicates a selection as the design decision, for example the selection of a specific product sheet from the cross-solution product documentation. A thick unbroken arrow indicates generating, for example generating system documents ADok3 from the engineering objects or, as the case may be, engineering data for a specific system or generating specific requirement rules from cross-system requirement rules. A double arrow indicates learning. Learning is a feedback loop from the specific workflow for a specific system to the general workflow rules of the cross-system engineering data.

It is therefore a learning method or, as the case may be, learning system where the engineering of industrial systems is successively simplified by means of automated knowledge accumulation and application. In contrast to customary methods of reusing individual, as large as possible system sections along with their engineering data and then adapting and integrating them manually, individual elementary behavior patterns and behavior rules as well as processing steps (meaning the engineering knowledge itself) are encapsulated in elementary workflow objects. It is therein characterized which engineering process can be employed in what circumstances (requirements).

For handling specific engineering projects finally the respective requirements are interpreted on an automated basis and, proceeding therefrom, the appropriate rule-based workflow objects are identified and adapted to the specific task in hand then combined into an overall workflow.

All automatable individual tasks of the workflows will then be handled automatically so that the only tasks remaining are those actually requiring new engineering knowledge not yet present in the system.

The method or, as the case may be, system being presented also has a feedback loop (double arrow “learning”) via which all new or modified procedures are identified and filed into the system as new engineering steps (in the form of rules) that can in the future be performed on an automated basis. The engineering knowledge contained in the databases will in that way gradually increase so that it will be possible over time for more and more engineering activities to be processed (interpreted, adapted, and employed) automatically.

Alongside objects relating to individual system components and engineering objects, especially the successively accumulated engineering knowledge that has been filed on a standardized basis is reused in the case of the method according to various embodiments. The result is that the overall workflow for handling an industrial system's engineering will be compiled from numerous standardized partial workflows and the individual engineering tasks will be handled on an automated basis wherever possible (meaning where the filed knowledge suffices).

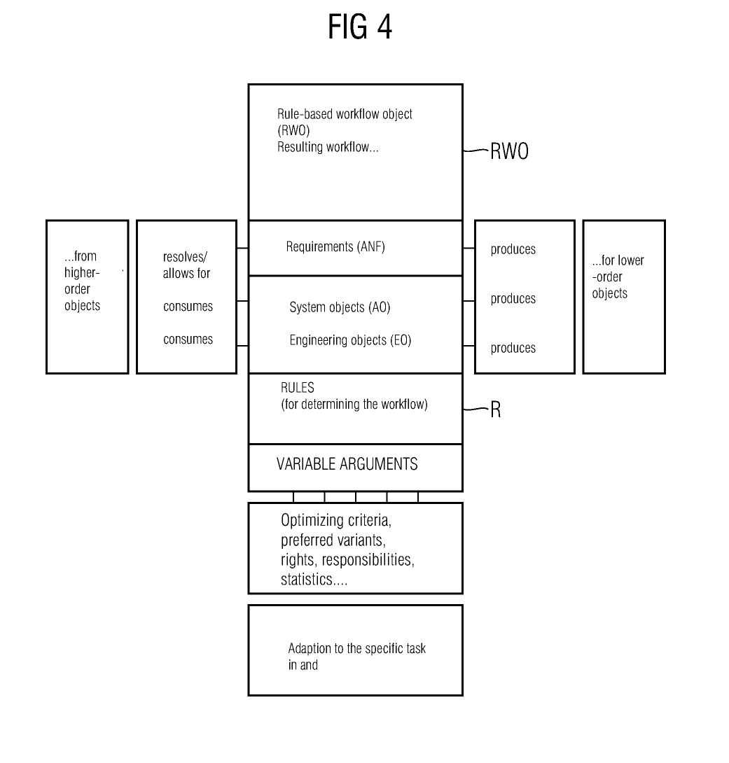

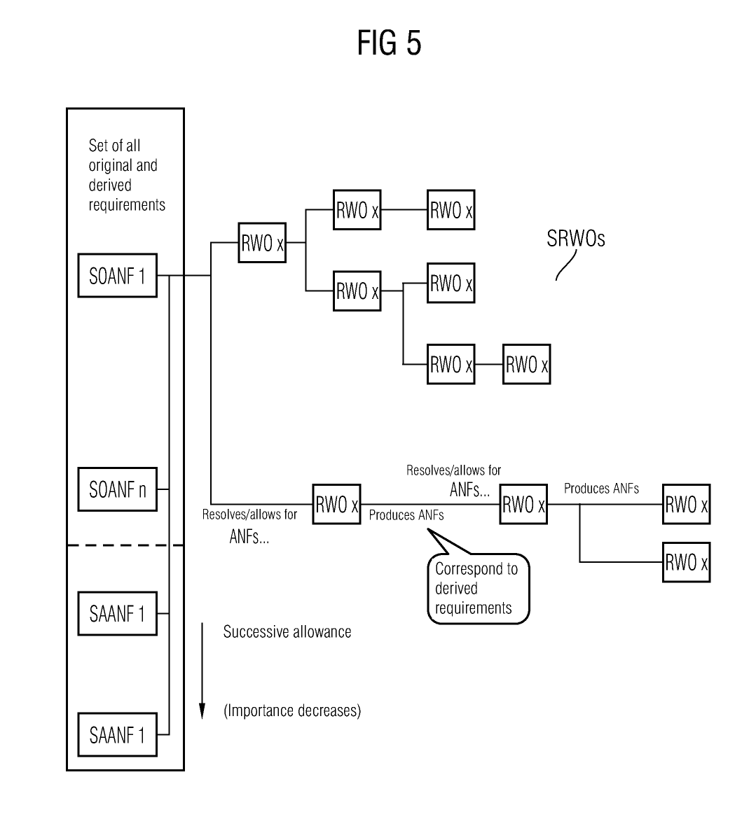

FIG. 4 shows an exemplary effect of a rule-based workflow object RWO when it is used in the system engineering. The aim of system engineering is to plan and design complete industrial systems (for example a factory), partial systems (for example a material-flow system in a factory), or partial components (for example a machine). A rule-based workflow object RWO substantially contains a description of under what circumstances which sequence of engineering tasks (workflow) is to be performed, which data/objects will be consumed and produced in the process, and which variation possibilities exist for meeting requirements of higher-order objects. The description is in the form of rules. The arguments likewise filed in the rule-based workflow object RWO are taken into consideration in interpreting or, as the case may be, processing said rules. The behavior of a rule-based workflow object RWO can be adapted to the respective situation via said arguments, but also via embedding in a specific RWO tree (see FIG. 5). While the workflow requiring to be derived therefrom is being processed, for each rule-based workflow object RWO all engineering data and engineering objects that arose during the process will be filed (directly or in the form of pointers or, as the case may be, links).

The rules employed are machine-readable specifications relating to the possible use of individual objects (for example rule-based workflow object RWO) and contain instructions (regarding, for example, degrees of freedom and variants, standards that have to be complied with, naming conventions, formats that have to be used, . . . ) applying to the performance of individual partial tasks within the workflow sequences. For describing rules of such kind it is possible to use rule-based languages such as, for instance, RC++ as a rule-based expansion of C++, Business Rule Markup Language (BRML), or Xcerpt.

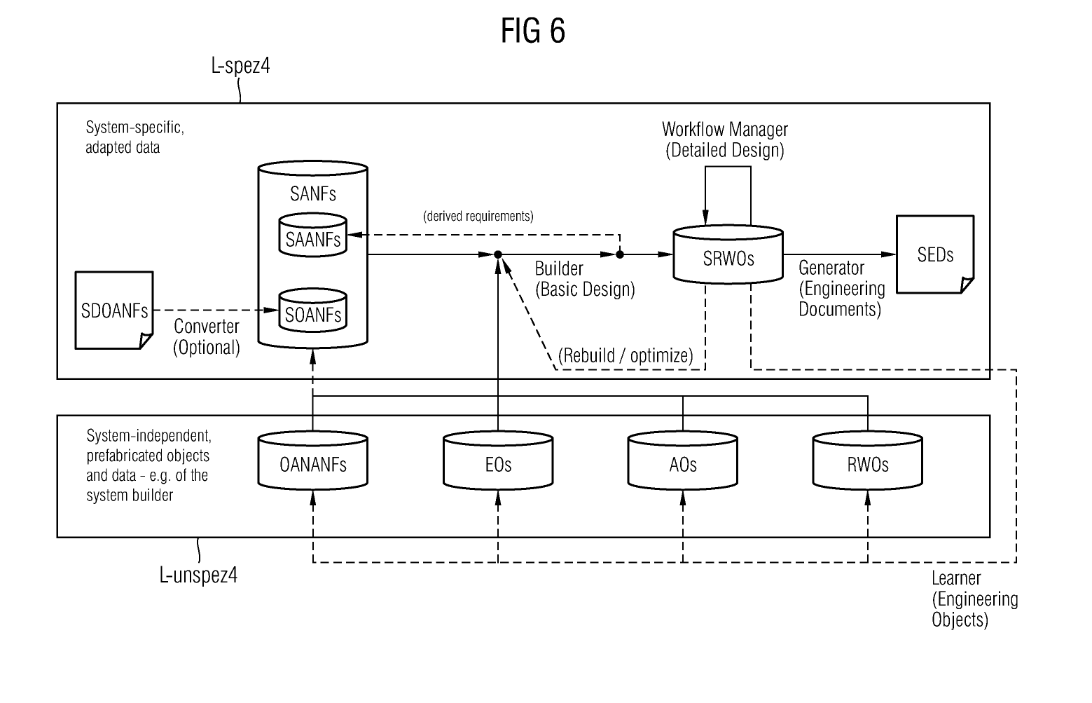

FIG. 5 shows an exemplary tree SRWOs of rule-based workflow objects RWOx after decomposition of the original and derived requirements placed an industrial system or partial system. The tree SRWOs of interlinked rule-based workflow objects RWOx which have been adapted to the individual, specific engineering tasks and are in sum capable of covering all existing requirements relating to engineering the specific system is generated by the builder (see FIG. 6). Said tree also constitutes the overall workflow requiring to be processed for the workflow manager's workflow engine (see FIG. 6) for implementing the “Detailed Design”. The tree SRWOs is generated based on the set of all original requirements SOANFs placed on a specific system, described in a standardized, machine-readable form and prioritized according to importance and based on the set of all derived specific requirements SAANFs resulting from the kind of solution in the Basic Design (of an industrial system), meaning the use of specific rule-based workflow objects along with its features and degrees of freedom.

FIG. 6 is a schematic exemplary overview diagram showing the interoperation of components and partial systems for implementing the method according to various embodiments. The top region L-spez4 of FIG. 6 includes system-specific, adapted data; the bottom region L-unspez4 of FIG. 6 includes system-independent prefabricated objects and data (for example components of a system builder).

Description of the Partial Systems and their Interoperation:

### Converter

Is an optional partial system of the system according to various embodiments. The converter is an editor that provides support with the partially automated conversion of non-machine-readable requirements (SDOANFs) into a standardized, machine-readable format. Said format can be based on, for instance, a machine-readable description language. Examples of languages for describing requirements are the “Requirement Description Language” (RDL) or CiNii. The converter therefore has functionalities for easily localizing passages of text that belong together and reading them in an edited structured form. The converter also has an editor that supports describing said requirements by means of the machine-readable language used (SOANFs). It will not be necessary to use the converter it that machine-readable format is present in any event.

### SDOANFs

Non-formatted documents with all original requirements (customer, domain, environmental conditions, . . . ) of the specific system whose engineering is to be implemented.

### SOANFs

The set of all original requirements placed on a specific system, described in a standardized, machine-readable form and prioritized according to importance.

### SANFs

Set of all specific requirements that have to be taken into account in engineering the specific system, meaning the sum of all requirements regardless of whether they are original in nature (SOANFs) or were derived from individual specific engineering decisions (SOANFs).

### Builder

The builder may be considered the most important partial system of the various embodiments. It is based on system-independent, already existing objects (OANANFs, EOs, AOs, and RWOs) and the engineering knowledge encapsulated therein and additionally employs the set of all system-specific requirements (SANFs) to generate a tree of rule-based, adapted workflow objects (RWOs) therefrom by means of automated decompensation. The result is equivalent in the hitherto customary engineering of industrial systems to what is termed “Basic Design”. The Basic Design of the resulting industrial system (meaning the definition of the functional concepts and system architecture) can therein be performed (in part or in total) optionally manually or on an automated basis. In the design decisions the builder takes the individual objects' degrees of freedom into account and the nature of the solution for comparable requirements (regardless of whether in the same or previous engineering projects). Apart from the interpretation of the filed rules, account is also taken of the arguments of the individual RWOs that may be considered (for example: Are the objects used in the RWO preferred variants? How often have they already been used? Is it also allowed to use them in this project with its own specific requirements? . . . ). If there are several possible design alternatives a suitable optimizing procedure will identify the optimum technologies and system sections and in that way generate a system topology that on the one hand conforms to the expected customer solution and, on the other hand, is optimal according to specific criteria (keyword: Key Performance Indicators—KPIs). It is assumed that the requirements present in SANFs are filed according to a specific priority. The requirements are therefore also processed in the corresponding sequence. That will insure that the most important design decisions are made at the outset and that all the builder's succeeding design decisions will take account of the decisions taken previously.

Individual design decisions can result in new requirements at all other RWOs. To insure they are taken into account, these what are termed derived requirements (SAANFs) are also included in the list of specific requirements (SANFs).

Which requirements are correlated therewith is filed in each RWO so that simple requirement tracing is possible. A tree (SRWOs) of rule-based workflow objects (RWOs) is established from the step-by-step decisions, with the individual RWOs being adapted to the respective specific task in the tree (activating/passivating/concretizing rules that are contained, setting attributes, linking with other objects, . . . ). If there is insufficient useful information to allow the relevant design decision to be taken in an automated manner, the builder will identify that and enable the decision to be taken manually by a human expert. Because the builder operates successively and takes account of all previous design decisions in all succeeding design decisions, it also allows a “Rebuild” or, as the case may be, “Optimize” after, for example, individual design decisions or requirements have been varied.

### Arguments

Arguments act as adjusting screws that influence, for example, the principal behavior and the degrees of freedom of the respective objects (for example RWOs). Examples of said adjusting screws are “extent of the safety requirements”, number of projects in which the object has so far been used, type of projects for which the object is suitable, excluding or preferring specific manufacturers or variants, national or customer-specific regulations, . . . ). Arguments can be both system-independent and system-specific. Possible information on how the arguments of individual objects such as EOs, AOs, or RWOs have to be set can originate from SANFs and OANANFs. Part of the arguments can also be influenced via the learner (for example statistical information on the frequency of use, etc.).

### SRWOs

Corresponds to a tree—established by the builder—of interlinked RWOs that have been adapted to the individual, specific engineering tasks and are in sum capable of covering all existing requirements relating to engineering the specific system. Said tree also constitutes the overall workflow requiring to be processed for the workflow engine for implementing the “Detailed Design”.

### Workflow Manager

The Workflow Manager contains a workflow engine that takes up the workflow respectively described in SRWOs and provides support therein in processing it (corresponds to the Detailed Design in conventional engineering). The resulting workflow proceeds from the situation-dependent interpretation of the attributes filed in the respective RWO and from the rules contained, and can if necessary be converted into a corresponding workflow description language (example: “Workflow Description Language” of the WWW Consortium or Business Process Execution Language) and then processed. The workflow engine contained therein monitors the status of individual engineering tasks' processing. Any gaps or deficits (unfulfilled requirements, missing components, . . . ) are also rendered transparent. It also identifies which engineering tasks can currently be processed by whom and which unaccomplished tasks are having a particularly obstructive impact on processing in the other construction fields. A statistical evaluation at any time establishes a measure of how far work has progressed (globally and in a manner specific to the individual role or, as the case may be, construction field). An interface to scheduling enables an “optimal” processing sequence to be determined automatically.

What is termed the “Virtual Expert” additionally permanently checks whether the workflow contains any partial tasks that could also be attended to automatically because of the available information. If it does, they will be processed automatically by the “Virtual Expert” on request without delay. Alongside the requirements, account will therein be taken of any other existing data and specifications and the corresponding engineering data derived therefrom and filed. Manual interactions will be necessary in the case of previously unknown, modified, or highly complex tasks. The implementing of such engineering tasks is supported by the system according to various embodiments by automatically identifying the respective partial task and embedding all requisite, already known data (requirements, interfaces, . . . ) in the overall workflow and displaying it in the manner necessary for the task (views that are specific to the particular construction field and kind of task, transferring the data to the corresponding engineering tools). The system provides additional support by searching for related tasks and presenting the user with the approaches to a solution it has found for being used and/or modified. When an engineering task is processed manually, the human expert is encouraged additionally to provide details of why he/she resolved the relevant task in the present manner. That information will later be used (in the learner) for automatically deriving further rules for the respective RWO and thus for (where possible) performing the engineering task automatically in future or at least supporting manual handling better. Regardless of whether the relevant engineering task is performed manually or automatically, the resulting engineering data will be included in the tree structure of the SRWOs or linked thereto.

### Generator

Is a place holder for the set of all document generators needed for producing from the engineering data contained in SRWOs all engineering documents (SEDs) required for setting up the industrial system. The resulting documents (SEDs) can be, for example, computer programs that will be integrated in the industrial system or cutover documents or documents that have to be supplied to the customer and will be read and must conform to the respectively applicable description rules. “JT”, the “Document Structure Description”, or “DOCBOOK” could therein be used as the replacement format/system.

### Rule

Rules are machine-readable specifications relating to the possible use of individual objects (for example RWOs) and contain instructions (regarding, for example, degrees of freedom and variants, standards that have to be complied with, naming conventions, formats that have to be used, . . . ) applying to the performance of individual partial tasks within the workflow sequences. Rule-based languages can serve to describe rules of such kind (examples: RC++ used for Sony WorkStation2, Business Rule Markup Language, or Munich university's Xcerpt).

### RWO

Corresponds to what is termed a “rule-based workflow object”. Objects of such kind substantially contain a description of under what circumstances which sequence of engineering tasks (workflow) is to be performed, which data/objects will be consumed and produced in the process, and which variation possibilities there are. The description is in the form of rules. The arguments likewise filed in the object are taken into consideration in interpreting or, as the case may be, processing said rules. The behavior of a RWOs can be adapted to the respective situation via said arguments, but also via embedding in the specific RWO tree (SRWOs). While the workflow requiring to be derived therefrom is being processed, for each RWO all engineering data and engineering objects that arose during the process will be filed (directly or in the form of links).

### RWOs

Database containing the set of all globally available, non-system-specific “rule-based workflow objects”. Said objects contain rules relating to the engineering of available products, product variants, partial systems, or lower-order RWOs.

### EOs

Database containing the set of all globally available, non-system-specific “engineering objects” (representatives of signal lists, wiring lists, cabinet plans, . . . ) required for producing the necessary engineering documents (SEDs).

### AOs

Database containing the set of all available non-system-specific “systems objects” (representatives of available physical system components, typicals, and partial systems that can be used in setting up specific systems).

### OANANFs

Original non-system-specific requirement of the system builder (global rules, accepted/unaccepted procedures, etc.).

### SAANFs

Set of all derived specific requirements resulting from the kind of solution in the Basic Design, meaning the use of specific RWOs along with its features and degrees of freedom.

### SEDs

Set of all specific engineering documents for setting up the specific system (circuit diagrams, wiring diagrams, construction diagrams, . . . )

### Learner

The learner identifies the places in the workflow where manual engineering took place. There the learner performs a post-analysis to determine what special features there were in the requirements and what assumptions/decisions were made during the solution-seeking process, and derives (to the extent possible) new rules therefrom. The frequency with which individual technologies (workflow and system sections) are employed (statistics) is furthermore also registered. Preferred variants for succeeding projects will in that way be formed automatically. Using suitable plausibility checks insures that only verified knowledge will be included in the knowledge database. Said rules can additionally also be verified and corrected manually. For that purpose they are submitted to a human expert via a suitable editor before being transferred to the system-independent objects (RWOs, AOs, EOs, OANANFs) as new knowledge (new rules).

Human experts can also enter rules independently of any specific system projects and file engineering knowledge in that way and make it accessible to the system according to various embodiments. A suitable rule language can be used for describing the respective rules.

The system or, as the case may be, method according to various embodiments generally puts the reuse of procedures in engineering to the fore in the engineering of industrial systems. Those engineering technologies correspond to a combination of present rules, using prefabricated system and engineering components, and rules for deriving workflow fragments for defining associated engineering data. The technologies that have been addressed are filed in suitable databases in the form of system-handling knowledge after being identified, generalized, and logged largely automatically in the handling of engineering projects. The reuse of solution components (system components and their associated engineering data) that are preconfigured or used in other projects is a consequence of that procedure.

In handling a new system's engineering, the method according to various embodiments automatically determines a proposal for the optimal system structure and the workflow necessary for engineering the system from the specific, machine-readable customer requirements, statistical variables of previous systems, and the filed system-handling knowledge and system objects. Based on the filed system-handling knowledge, the system according to various embodiments furthermore automatically performs all engineering tasks that can be performed automatically so that the only tasks remaining are those that hitherto could not be handled automatically owing to a lack of knowledge or excessive complexity.

### The Above-Presented Engineering Method or, as the Case May be, System Offers in Particular the Following Advantages:

Minimizing the proportion of manual engineering tasks and the communication effort required of the personnel involved to the extent necessary through the automatic reuse of engineering decisions. Automatic handling of all engineering tasks for which the requisite engineering knowledge is already contained in the system according to various embodiments.
Addressing the dearth of specialist workers that is even starting to affect industrial-system engineering. Automated transfer of changed or new manual behavior patterns in engineering into new engineering knowledge that can be utilized on an automated basis. That gives rise to relatively low startup costs because knowledge is successively acquired on an automated basis.
More flexibility results in optimized systems. Possibility of automatically identifying an “optimal solution” according to specific criteria (KPIs). Using many small, automatically selectable and configurable objects instead of just a few, restricting and confusing mammoth objects that have to be selected and set manually.
Insuring automatically that all requirements are met.
Flexible adaptability of the system solution to individual customer wishes and boundary conditions (for example incorporating existing components, accepting higher-level engineering effort to achieve lower lifecycle costs, . . . ).
Faster and more streamlined handling of manual engineering tasks. Role- and situation-specific presentation of waiting tasks together with the already known information needed therefor. It is therein insured that the various roles consistently follow one common project goal instead of, for instance, numerous broken-down construction-field objectives.
Reusability even across the boundaries of specific types of system and construction fields.
No need to manually define large, artificially created, difficult-to-define, difficult-to-maintain, and possibly inflexible engineering units (such as, for example, mechatronic objects).
Traceability: Automatic linking of the requirements to the solution artifacts.
Support during the offer phase: Automated identification of which requirements are new, which is to say pointing up what is different compared with previous system solutions and so could cause problems.→Consequences are more transparent—weighing up and costing have a firmer basis!
Automatic availability of accumulated knowledge about all previously handled systems (not just the objects defined at some time as the standard).
New win-win situations can be implemented: Price discounts are possible; if the customer defines the requirements in the specified machine-readable form (standard!) there will also be closer ties to component suppliers who provide objects conforming to the present method.
It is more advantageous to take both steps (introducing mechatronic objects and knowledge-based system handling) simultaneously than each step separately.
Example: The mechatronic objects whose definition is otherwise effort-intensive would therein take the possibilities of the learning approach according to various embodiments into account and would hence not have to be so complex and satisfy such demanding conditions.
Possibility of including non-functional requirements

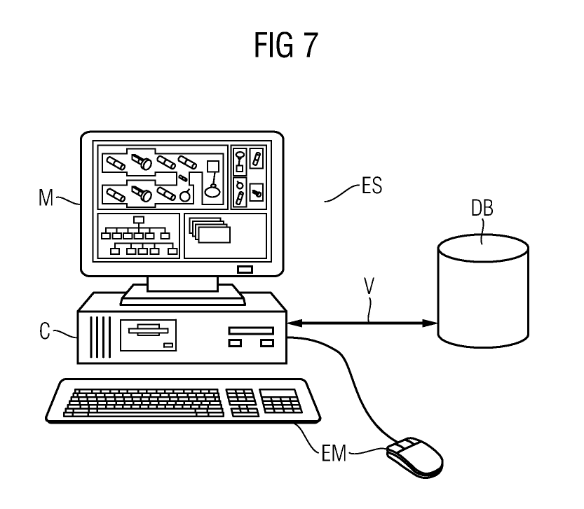

FIG. 7 shows an exemplary device ES (for example an engineering system) for implementing the method according to various embodiments. The method is realized by means of software (C, C++, Java etc.) and can be put into effect by a computer-program product that causes the method to be executed in a program-controlled device C. The software can furthermore be stored on a computer-readable medium (for example a floppy disk, CD, Smart Media Card, or USB stick) including instructions which, when executed on a suitable computer C, will cause the computer C to implement the method. The device ES includes a screen M for graphically displaying the engineering and system objects or, as the case may be, their interconnections, input means EA (for example a mouse, keyboard, or touch pen) for selecting and manipulating the objects, storage means DB for archiving created objects or, as the case may be, models, and a processing unit C. The processing unit C can be a commercially available computer (for example a laptop or PC) or it can correspond to a networked client-server computer system having a plurality of user access points (for example a plurality of central servers and as well as a plurality of client PCs). The method can basically also be realized by means of distributed computer architectures (clusters, cloud computing) or on a web basis.

Method and engineering system for designing industrial systems on the basis of system-independent, rule-based, configurable, incremental workflow objects, with a tree of workflow objects that represents the workflow requiring to be executed for generating the engineering documents of the target system that is being designed being generated from the workflow objects by means of functional decompensation, and with a system layout being generated from the identified system objects and by way of interpreting the data, objects, and rules of the workflow objects contained in the tree, these being processed by a workflow engine, and with engineering data specific to the target system being generated therein and the engineering documentation necessary for the system that is being designed being generated by document generators in the respectively necessary form. Alongside system objects and engineering objects, especially the successively accumulated engineering knowledge that has been filed on a standardized basis is reused.

### LIST OF REFERENCE LETTERS/NUMERALS

RDok1-RDok3 Requirement documents
E-Data1-E-Data3 Engineering data
A&EDok1-A&EDok3 Offer & engineering documents
ADok1-ADok3 System documents
L-spez1-L-spez4 Solution-specific
L-unspez1-L-unspez4 Cross-solution
RWO, RWOx Rule-based workflow object
RWOs Database containing the set of available, non-system-specific rule-based workflow objects
SRWOs Tree of rule-based workflow objects
R Rule
SOANF1-SOANFn Original requirement placed on a specific system
SOANFs Set of original requirements placed on a specific system
SAANF1-SAANFm Derived specific requirement
SAANFs Set of all derived specific requirements
SANFs Set of all specific requirements that have to be taken into account in engineering the specific system
SDOANFs Unformatted documents containing original requirements of a specific system
SEDs Set of all specific engineering documents
OANANFs Original non-system-specific requirements of the system builder
EOs Database containing the globally available, non-system-specific engineering objects
AOs Database containing the set of available, non-system-specific system objects
ES Engineering system
M Monitor
C Computer system
DB Database
V Connection
EM Input means

What is claimed is:

1. A method for designing industrial systems on the basis of system-independent, rule-based, configurable workflow objects, with a workflow object comprising a standardized machine-readable description of an incremental engineering task, a standardized machine-readable description of data and objects that are at least one of consumed and generated in the performance of the engineering task, and standardized machine-readable rules according to which the engineering task is to be performed, the method comprising:
compiling the specification of requirements applying to the system that is being designed on the basis of standardized machine-readable requirements,
identifying the workflow objects and system objects necessary for generating the engineering tasks required by the specification of requirements from a set of workflow objects and a set of system objects representing physical system components of an industrial system requiring to be designed,
generating a tree of workflow objects that represents the workflow requiring to be executed for generating the engineering documents of the target system that is being designed from the identified workflow objects by means of functional decompensation,
generating a system layout from the identified system objects and by way of interpreting the data, objects, and rules of the workflow objects contained in the tree, processing the workflow objects by a workflow engine, and generating the engineering documentation necessary for the system that is being designed in the respectively required format by document generators in the form of resulting engineering documents.

2. The method according to claim 1, wherein requirements are converted into a machine-readable form if not already in a machine-readable form.

3. The method according to claim 1, wherein the workflow objects are classified as being domain-specific or, as the case may be, discipline-specific and non-domain-specific or, as the case may be, non-discipline-specific.

4. The method according to claim 1, wherein from the set of all project-specifically employed workflow objects the workflow objects that were produced, modified, or processed manually are identified, and wherein said workflow objects are transferred to the set of machine-readable workflow objects with the associated data, objects, and rules.

5. The method according to claim 4, wherein before the data, objects, and rules are transferred to the set of machine-readable workflow objects the latter are classified as being domain-specific or, as the case may be, discipline-specific and non-domain-specific or, as the case may be, non-discipline-specific.

6. The method according to claim 4, wherein before the data, objects, and rules are transferred to the set of machine-readable workflow objects the latter are analyzed in terms of a general applicability.

7. A device for designing industrial systems on the basis of system-independent, rule-based, configurable workflow objects, comprising a workflow object comprising a standardized machine-readable description of an incremental engineering task, a standardized machine-readable description of data and objects that are at least one of consumed and generated in the performance of the engineering task, and standardized machine-readable rules according to which the engineering task is to be performed, wherein the device is operable:
to compile the specification of requirements applying to the system that is being designed on the basis of standardized machine-readable requirements,
to identify the workflow objects and system objects necessary for generating the engineering tasks required by the specification of requirements from a set of workflow objects and a set of system objects representing physical system components of an industrial system requiring to be designed,
to generate a tree of workflow objects that represents the workflow requiring to be executed for generating the engineering documents of the target system that is being designed from the identified workflow objects by means of functional decompensation,
to generate a system layout from the identified system objects and by way of interpreting the data, objects, and rules of the workflow objects contained in the tree, to process the workflow objects by a workflow engine, and to generate the engineering documentation necessary for the system that is being designed in the respectively required format by document generators in the form of resulting engineering documents.

8. The device according to claim 7, wherein the device is an engineering system.

9. The device according to claim 7, wherein requirements are converted into a machine-readable form if not already in a machine-readable form.

10. The device according to claim 7, wherein the workflow objects are classified as being domain-specific or, as the case may be, discipline-specific and non-domain-specific or, as the case may be, non-discipline-specific.

11. The device according to claim 7, wherein from the set of all project-specifically employed workflow objects the workflow objects that were produced, modified, or processed manually are identified, and wherein said workflow objects are transferred to the set of machine-readable workflow objects with the associated data, objects, and rules.

12. The device according to claim 11, wherein before the data, objects, and rules are transferred to the set of machine-readable workflow objects the latter are classified as being domain-specific or, as the case may be, discipline-specific and non-domain-specific or, as the case may be, non-discipline-specific.

13. The device according to claim 11, wherein before the data, objects, and rules are transferred to the set of machine-readable workflow objects the latter are analyzed in terms of a general applicability.

14. A computer-program product comprising a computer readable medium storing instructions which when executed by a computer causes a program-controlled device for designing industrial systems on the basis of system-independent, rule-based, configurable workflow objects, comprising a workflow object comprising a standardized machine-readable description of an incremental engineering task, a standardized machine-readable description of data and objects that are at least one of consumed and generated in the performance of the engineering task, and standardized machine-readable rules according to which the engineering task is to be performed,
to compile the specification of requirements applying to the system that is being designed on the basis of standardized machine-readable requirements,
to identify the workflow objects and system objects necessary for generating the engineering tasks required by the specification of requirements from a set of workflow objects and a set of system objects representing physical system components of an industrial system requiring to be designed,
to generate a tree of workflow objects that represents the workflow requiring to be executed for generating the engineering documents of the target system that is being designed from the identified workflow objects by means of functional decompensation,
to generate a system layout from the identified system objects and by way of interpreting the data, objects, and rules of the workflow objects contained in the tree, to process the workflow objects by a workflow engine, and to generate the engineering documentation necessary for the system that is being designed in the respectively required format by document generators in the form of resulting engineering documents.

15. The computer program product according to claim 14, wherein requirements are converted into a machine-readable form if not already in a machine-readable form.

16. The computer program product according to claim 14, wherein the workflow objects are classified as being domain-specific or, as the case may be, discipline-specific and non-domain-specific or, as the case may be, non-discipline-specific.

17. The computer program product according to claim 14, wherein from the set of all project-specifically employed workflow objects the workflow objects that were produced, modified, or processed manually are identified, and wherein said workflow objects are transferred to the set of machine-readable workflow objects with the associated data, objects, and rules.

18. The computer program product according to claim 17, wherein before the data, objects, and rules are transferred to the set of machine-readable workflow objects the latter are classified as being domain-specific or, as the case may be, discipline-specific and non-domain-specific or, as the case may be, non-discipline-specific.

19. The computer program product according to claim 17, wherein before the data, objects, and rules are transferred to the set of machine-readable workflow objects the latter are analyzed in terms of a general applicability.
